(19) United States
(12) Patent Application Publication
(10) Pub. No.: US 2008/0306886 A1
(43) Pub. Date: Dec. 11, 2008

(54) Graphical user interface adaptation system for a point of sale device

(75) Inventors: Jonathan Otto, Palm Beach, FL (US); Andrew Van Luchene, Santa Fe, NM (US); Michael R. Mueller, San Francisco, CA (US); Raymond J. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, West Palm Beach, FL (US)

(21) Appl. No.: 12/151,041

(22) Filed: May 2, 2008

Related U.S. Application Data
(63) Continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06F 3/048; G06Q 20/00; G06F 17/00

(52) U.S. Cl. 706/11; 705/16; 715/700

(57) ABSTRACT

A system for controlling a graphical user interface (GUI) for a point of sale device (POSD), including: a tracking element, in a processor for at least one specially-programmed computer, to track, using an interface element in the computer, respective responses, by end users, to a plurality of implementations of at least one input/output (I/O) function by respective GUIs for at least one first POSD; a comparison element, in the processor, to compare the respective responses with a performance parameter stored in a memory unit for the computer; and a configuration element, in the processor, to configure at least one second I/O function in accordance with the comparison of the respective responses with the performance parameter and arranged to transmit, using the interface element, the at least one second I/O function configuration to at least one second POSD for implementation by respective GUIs for the at least one second POSD.

### CROSS-REFERENCE TO RELATED APPLICATIONS

This is a continuation-in-part patent application under 35 USC 120 of a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a system and a method for controlling a graphical user interface (GUI) for a point of sale device (POSD); specifically, to automatically optimize presentations on the GUI with respect to performance parameters.

### BACKGROUND OF THE INVENTION

Operators, such as cashiers, using point of sale devices (POSDs) in retail locations become expert at using graphical user interfaces (GUIs) for the respective POSDs. For example, for a touch screen of a GUI, the cashier may touch the screen ahead of the appearance of a display on the GUI, that is, the cashier buffers the keystrokes. However, many times, GUI functions, for example, screen layouts, are suboptimal given the tasks more generally performed by the cashier. Oftentimes, GUI screens are designed with the “least common denominator” in mind, which usually means the untrained cashier. While this configuration is optimal during training and makes such systems easier to use for the uninitiated, the designs are usually not optimal from the perspective of a trained cashier, who would often prefer to skip certain steps. Moreover, many times there are buttons or functions on a given GUI that are relatively unused, adding to the clutter on the screen or otherwise distracting the operator from those functions that are relevant to the more popular tasks performed by the operator. Unfortunately, suboptimal GUI functions reduce productivity in retail environments.

It is known to present sales offers, menus, and promotions on a GUI for a POSD. The presentations can be directed to an operator of the POSD or to a customer using the POSD. Unfortunately, the presentations are not automatically optimized to increase performance with respect to a performance parameter such as degree of acceptance of the presentation or operational considerations for a retail location associated with the presentation on the POSD.

Thus, there is a long-felt need to provide a system and a method to control a GUI for a POSD; specifically, to automatically optimize presentations on the GUI with respect to performance parameters.

### SUMMARY OF THE INVENTION

The invention broadly comprises a system for controlling a graphical user interface (GUI) for a point of sale device (POSD), including: a tracking element, in a processor for at least one specially-programmed computer, arranged to track, using an interface element in the computer, first respective responses, by at least one end user, to a plurality of implementations of at least one first GUI input/output (I/O) function by respective GUIs for at least one first POSD; a comparison element, in the processor, arranged to compare the first respective responses with a first performance parameter stored in a memory unit for the computer; and a configuration element, in the processor, arranged to configure at least one second GUI I/O function in accordance with the comparison of the first respective responses with the first performance parameter and arranged to transmit, using the interface element, the at least one second GUI I/O function configuration to at least one second POSD for implementation by respective GUIs for the at least one second POSD.

In a first embodiment, the system includes an identification element, in the processor, arranged to identify, using the interface element, a specific end user of the GUI; and, the tracking element is arranged to track first respective responses for the specific end user, the comparison element is arranged to compare the first respective responses for the specific end user, the configuration element is arranged to configure a specific GUI I/O function for the specific user in accordance with the comparison of the first respective responses for the specific end user, and the configuration element is arranged to transmit the specific GUI S/O function configuration to the second POSD when the specific user is identified at the POSD.

In a second embodiment, the first performance parameter is associated with first sales activity at a retail location. In one embodiment, the first sales activity is speed for placement of an order using the first respective GUIs, maximum profit for the order, maximum total for the order, lowest return rate, or sales activity for a plurality of orders placed using the first respective GUIs. In another embodiment, the first performance parameter is associated with an additional sales activity at the retail location or includes a temporal parameter.

In a third embodiment, the first performance parameter is a frequency of usage of the at least one first GUI I/O function by the at least one end user and the configuration element is arranged to enable the second I/O function according to the frequency of usage of the at least one first GUI I/O function. In one embodiment, the configuration element is arranged to disable the at least one second GUI I/O function if the frequency of usage of the at least one first GUI I/O function is below a predetermined threshold.

In a fourth embodiment, the tracking element is arranged to generate at least one executable using at least one of a set of rules and an artificial intelligence program stored in a memory unit of the computer and to track the first respective responses using the at least one executable. In a fifth embodiment, the configuration element is arranged to generating at least one executable using a set of rules and/or an artificial intelligence program stored in a memory unit of the computer and to configure the at least one second GUI I/O function using the at least one executable. In a sixth embodiment, the configuration element is arranged to configure the at least one second GUI I/O function in real time or at a predetermined interval. In a seventh embodiment, the at least one end user is at least one customer and the first performance parameter is acceptance of a first offer by the at least one customer or a sales activity at the retail location associated with a second offer made to the at least one customer.

In an eighth embodiment, the configuration element is arranged to generate at least one third GUI I/O function different than the at least one first GUI I/O function and to transmit the at least one third GUI I/O function to at least one third POSD for implementation by third respective GUIs for the at least one third POSD; the tracking element is arranged to track second respective responses, by the at least one end user, to a plurality of implementations of the at least one third GUI I/O function by the third respective GUIs; the comparison element is arranged to compare the second respective responses with the first performance parameter; the comparison element is arranged to compare the comparison of the first respective responses with the first performance parameter with the comparison of the second respective responses with the first performance parameter; and the configuration element is arranged to configure the least one second GUI I/O function in accordance with the comparison of the comparison of the first respective responses with the first performance parameter with the comparison of the second respective responses with the first performance parameter. In one embodiment, the tracking element is arranged to generate at least one executable using at least one of a set of rules and an artificial intelligence program stored in a memory unit of the computer and to generate the at least one third GUI I/O function using the at least one executable.

In a ninth embodiment, the first and second I/O functions are the same. In a tenth embodiment, the tracking element is arranged to generate at least one executable using at least one of a set of rules and an artificial intelligence program stored in a memory unit of the computer and to generate, using the processor and the at least one executable, the first performance parameter.

The invention also broadly comprises a computer-based method for controlling a graphical user interface (GUI) for a point of sale device (POSD).

It is a general object of the present invention to provide a system and a method to automatically optimize a GUI for a POSD.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for controlling a graphical user interface (GUI) for a point of sale device (POSD); and,

FIGS. 2A and 2B are a flow chart of a present invention method for controlling a graphical user interface (GUI) for a point of sale device (POSD).

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Coupon—includes an offer presented in the form of an electronic or printed ticket or document which may include a discount or rebate when purchasing one or more products from a business or sponsor. In certain embodiments, a coupon may include a bar code, RFID, or other means of identification, which may include information that can verify any one or more of the type of coupon, valid offer dates, customer, business or sponsor information, discount amounts, restrictions, permissions, items required to purchase to receive a discount or rebate, and/or items to which a discount or rebate applies, location information, including where the coupon is valid, e.g., which store or stores, or website, and/or any other information that might assist or be of benefit to the issuer or recipient or the processor, e.g., a cashier, and/or the processing system, e.g., a POS terminal or POS system, and/or a sponsor or other business entity, and/or any information that might encourage distribution, delivery, redemption or use of any such coupon or that might improve the results of any coupon or coupon marketing campaign, e.g., a viral marketing campaign or new product introduction.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requester.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Cafe's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program.

Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Referral Coupon—includes a marketing message, marketing offer, or other offer, including, for example, a coupon provided to an existing member for providing the identity or other information of a prospective member and/or an action taken by such prospective member, including, for example, such prospective member becoming a member and/or accepting a similar or other marketing offer, e.g., by redeeming a coupon.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings. In some embodiments a referral coupon may be a reward and/or a reward may be a referral coupon. In certain embodiments a referral coupon may be a viral coupon and vice versa.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Trial Coupon—includes any offer that encourages the purchase of a new item or an item an end user has not yet tried, which offer may be presented using any applicable means, including use of an electronic or printed coupon.

Upsell—includes any offer to purchase one or more items at a full, discounted or other price including the retail price. Upsells include offers to increase an order size, quantity, type or contents of an entity's, e.g., a customer's order.

Upsell/Instruction/Commission Output device—includes, but is not limited to: a POS terminal, a website, a drive through or other digital menu board, a drive through speaker, a cell phone, telephone, pager or PDA, a kiosk, a vending machine, a customer counter display, an in-store or other digital menu board, a display built into a restaurant table, a vending machine, a speaker, or slot machine.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npil/msnt.asp” target=“top”><IMG SRC=“/chan/home/lozo.gif” WIDTH=140 HEIGHT=60 BORDER=0 ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE INC, John Wiley & Sons, Inc. 2d ed., 1996, which is incorporated by reference in its entirety.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only or the other of A and B.

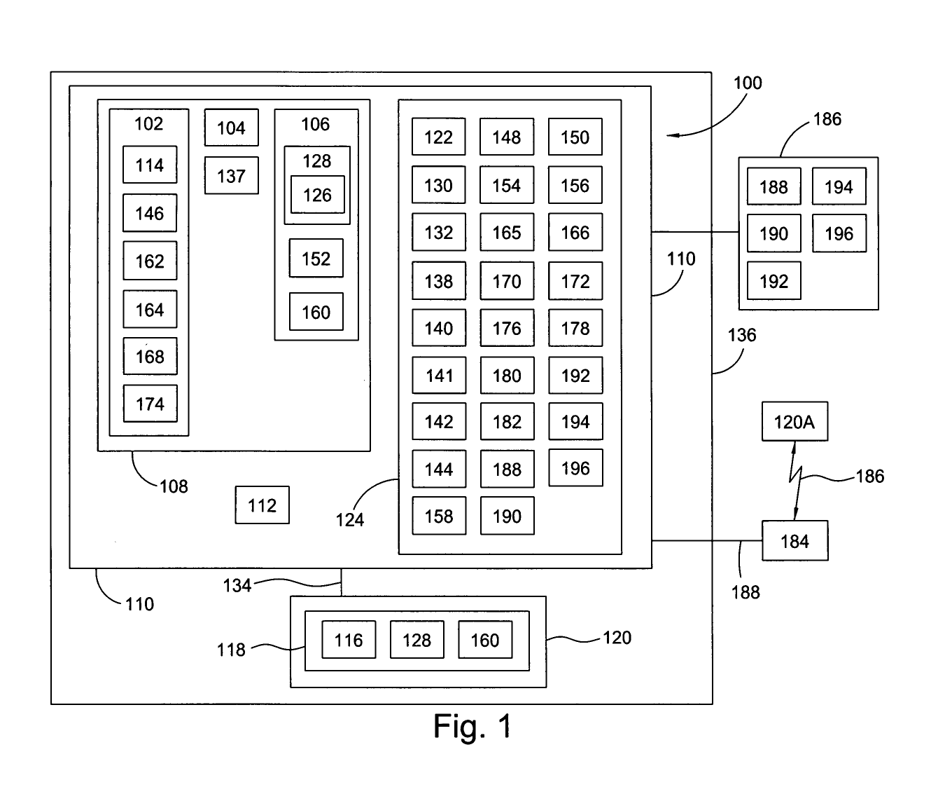

FIG. 1 is a block diagram for present invention system 100 for controlling a graphical user interface (GUI) for a point of sale device (POSD). System 100 includes tracking element 102, comparison element 104, and configuration element 106, all in processor 108 in at least one specially-programmed computer 110. Alternately stated, elements 102, 104, and 106, and any other elements described as being in the processor, are functions of the processor or are functions carried out by the processor. The tracking element is arranged to track, using interface element 112 in the computer, respective responses 114, by at least one end user (not shown), to a plurality of implementations of at least one GUI input/output (I/O) function 116 by respective GUIs 118 for at least one POSD 120. The comparison element is arranged to compare the respective responses with a performance parameter 122 stored in memory unit 124 for the computer. The configuration element is arranged to generate configuration 126 for at least one GUI I/O function 128 in accordance with the comparison of respective responses 114 with performance parameter 122. The configuration element also is arranged to transmit, using the interface element, the GUI I/O configuration 126 to POSD 120 for implementation by GUI 118.

In one embodiment, the tracking element generates tracking history 130 and the comparison element generates comparison history 132. The tracking history relates to the responses 114. Both histories are stored in the memory unit. It should be understood that the histories can be stored in another system or memory unit (not shown) and retrieved by computer 110 as needed.

By I/O function we mean any function of the GUI that provides information, including, but not limited to: text on a screen, buttons on a touch screen, video on a screen, or an audio message from a speaker or headphone; or any function that accepts input of information, including, but not limited to: input from a keyboard, input from a touch screen, or input from a microphone. By implementing an I/O function we mean that the GUI carries out the function, for example, the GUI displays a button on a touch screen or accepts an input from a keyboard.

By interface element, we mean any combination of hardware, firmware, or software in a computer used to enable communication or data transfer between the computer and a device, system, or network external to the computer. The interface element can connect with the device, system, or network external to the computer, for example, POSD 120, using any means known in the art, including, but not limited to a hardwire connection, an optical connection, an Internet connection, or a radio frequency connection. In the figures, a non-limiting example of a hardwire connection 134 is shown. Processor 108 and interface element 112 can be any processor or interface element, respectively, or combination thereof, known in the art.

Computer 110 can be any computer or plurality of computers known in the art. In one embodiment, the computer is located in a retail location with which system 100 is associated, for example, location 136. In another embodiment (not shown), all or parts of the computer are remote from retail locations with which system 100 is associated. In a further embodiment, computer 110 is associated with a plurality of retail locations with which system 100 is associated. Thus, the computer provides the functionality described for more than one retail location.

For the sake of simplicity, only a single POSD is shown in FIG. 1. However, it should be understood that more than one POSD can be interfaced with computer 110 to track responses at the multiple POSDs. It also should be understood that configuration 126 can be transmitted to more than one POSD. It should be further understood that the one or more POSDs implementing '10 functions 116 and 128 can be the same POSDs, different POSDs, or any combination of the same or different POSDs.

POSD 120 can be any POSD known in the art. The following are non-limiting examples of POSDs or POSD components usable in system 100:

1. A touch screen controlled by a cashier.

2. A kiosk controlled by a customer, or consumer.

3. A screen connected to a POSD that can be controlled by a consumer.

4. A wireless communications device (WCD) owned and/or controlled by a consumer.

5. A GPS or other display device mounted in the vehicle of a consumer.

6. A PC connected to a website for web entry and ordering by a cashier or consumer.

7. A microphone that can receive voice commands from a consumer or cashier.

8. An order entry device at the menu board sign of a drive through or parking space.

9. An order fulfillment device located at the drive through window.

The configuration element is arranged to configure function 128 in real time or at predetermined intervals. In one embodiment functions 116 and 128 are the same; for example, I/O function 116 is a button on a touch screen for GUI 118 and the button is configured by the configuring element to be further displayed or removed from the touch screen according to the comparison with parameter 122. In another embodiment, functions 116 and 128 are different; for example, I/O function 116 is a button on a touch screen for GUI 118 and I/O function 128 is a drop down menu configured by the configuring element to be displayed or removed from the touch screen according to the comparison with parameter 122.

In one embodiment, system 100 functions without the respective identifications of end users, or the identification are known, but the functions of system 100 are not tailored to the respective identities. For example, I/O function 116 is a button on a touch screen for GUI 118 and the comparison with parameter 122 shows that the button is rarely used in general, or is rarely used during certain time intervals. In response, the button is configured by the configuring element not to be further displayed on the touch screen or only displayed outside of the certain time intervals.

In another embodiment, the identification of the end user or users is known and is used to influence the functions of system 100. In this embodiment, system 100 includes identification element 137, in the processor, arranged to identify, using the interface element, a specific end user (not shown) of the GUI. The tracking element is arranged to track responses 114 for the specific end user, the comparison element is arranged to compare the responses 114 for the specific end user to parameter 122, the configuration element is arranged to generate a specific GUI I/O configuration 126 for the specific user in accordance with the comparison of the responses for the specific end user, and/or the configuration element is arranged to transmit the specific GUI I/O function configuration to the POSD when the specific user is identified at the POSD. For example, I/O function 116 is a button on a touch screen for GUI 118 and the comparison with parameter 122 shows that a user X always uses the button in conjunction with a pull down menu. In response, the button is configured by the configuring element not to be further displayed on the touch screen and instead, the pull down menu is displayed, skipping an intermediate display, or step.

The identity of the end user an be obtained by any means known in the art, for example, via the WCD noted above, the customer can supply identification information to the POSD, for example, by a loyalty card, or the end user can be a cashier who logs in.

In a preferred embodiment, the performance parameter is associated with sales activity 138 at the retail location. In one embodiment, sales activity 138 is associated with, but is not limited to, an order 140 placed by the at least one end user using GUI 118. Metrics considered with respect to activity 138 include, but are not limited to, speed of the order, maximum profit for the order, maximum total for the order, and lowest return rate. The return rate is the rate at which an item is returned to the location, for example, for refund or exchange. In another embodiment, sales activity 138 is for a wider range of sales activity at the retail location, for example, sales activity associated with a plurality of orders placed using GUI 118. Sales activity 138 and order 140 are shown as data stored in memory element 124 of the computer; however, it should be understood that sales activity or the order can be retrieved by computer 112, via the interface element, for use by the processor, from another system or memory unit (not shown) or can be generated by processor 110.

In another embodiment, a second configuration step is performed, namely, the configuration element is arranged to configure I/O function 128 in response to a combination of parameter 114 and parameter 141, associated with sales activity 142 at the retail location, or with temporal parameter 144. Sales activity 142 can include all or some of the metrics noted above for sales activity 138. Temporal parameter 144 can be, but is not limited to, a time of day or a day of the week, month, or year. Parameter 141, sales activity 142 and parameter 144 are shown as data stored in memory element 138 of the computer; however, it should be understood that the parameter, the sales activity and/or the temporal parameter can be retrieved by computer 112, via the interface element, for use by the processor, from another system or memory unit (not shown) or can be generated by processor 110. In yet another embodiment, parameter 114 is associated with a temporal parameter, for example, parameter 144. Parameters 114 and 141 are further described below.

In a preferred embodiment, performance parameter 114 is a frequency of usage of I/O function 116, for example, by a customer (not shown) of the retail location or by an employee (not shown) of the retail location operating the POSD. In this case, the configuration element is arranged to enable I/O function 128, for example, operate the GUI to execute, or present, I/O function 128 according to the frequency of usage. For example, the greater the usage of function 116, the greater the chance that function 128 is implemented in the future. In one embodiment, the configuration element is arranged to disable I/O function 128 if the frequency of usage of function 116 is below a predetermined threshold. For example, if I/O function 116 is used less than 20% of the time that the function is executed on the GUI, function 128 is no longer presented.

The performance parameters and metrics noted supra can be applied at different times of the day or at various thresholds of transaction throughput. For instance the system can optimize speed of order during busy times and maximum check amount during slow times.

In a first embodiment, tracking element 102 is arranged to generate at least one executable 146 using one or both of set of rules 148 and artificial intelligence program 150 stored in the memory unit. In this case, tracking element 102 is arranged to use executable 146 to track respective responses 114. In one embodiment, executable 146 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 186, separate from computer 110, transmits modifying rule 188 to computer 110. Computer 186 can be in location 136 (not shown) or can be in a different location. Computer 186 can be associated with a business entity associated with location 136 or can be associated with a different business entity. In another embodiment (not shown), multiple computers 186 are included and respective computers among the multiple computers can be associated with the same or different business entities. Computer 110 stores modifying rule 188 in memory 124. Element 102 modifies executable 146 using rule 188. Computer 186 generates rule 188, and element 102 modifies executable 146, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In a second embodiment, configuration element 106 is arranged to generate at least one executable 152 using at least one of a set of rules 154 or artificial intelligence program 156 stored in the memory unit. In this case, configuration element 108 is arranged to generate configuration 126 using executable 152. In one embodiment, executable 152 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 186 transmits modifying rule 190 to computer 110. Computer 110 stores modifying rule 190 in memory 124. Element 106 modifies executable 152 using rule 190. Computer 186 generates rule 190, and element 106 modifies executable 152, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In a third embodiment, the at least one end user is at least one customer and functions 116 and 128 are the same offer, for example, an offer to purchase one or more items at location 136. In this case, performance parameter 114 is acceptance of the offer by the customer and the configuration element is arranged to generate configuration 126 in accordance with the acceptance of the offer. For example, the tracking element tracks a percentage of the acceptance of the offer by the customer, or a plurality of customers, and links the frequency of the presentation of the offer to the percentage of acceptance. For example, the offer is presented with greater frequency if the percentage of acceptance is high. As another example, if an acceptance level of the offer is below a certain threshold, the presentation of the offer is enhanced, for example, the size, color, or dynamics of a visual offer presentation are modified or an audio portion is added to the presentation.

In a fourth embodiment, the at least one end user is at least one customer and functions 116 and 128 are the same offer, for example, an offer to purchase one or more items at location 136. In this case, performance parameter 114 is sales activity 158 at the retail location associated the offer and the configuration element is arranged to generate configuration 126 in accordance with sales activity 158. For example, the tracking element can track operational parameters such as profit, size of order, inventory on hand, etc. as related to the presentation of the offer. For example, if an increase in profit size or margin is associated with presentation of the offer, the offer is presented with greater regularity or the presentation of the offer is enhanced or modified as described supra. Sales activity 158 is shown as data stored in memory element 124 of the computer; however, it should be understood that sales activity can be retrieved by computer 110, via the interface element, for use by the processor, from another system or memory unit (not shown) or can be generated by processor 108.

In a fifth embodiment, system 100 works in an exploratory or experimental mode to generate and evaluate optimal I/O functions and GUI configurations. In this embodiment, the configuration element is arranged to generate at least one GUI I/O function 160 different than function 116 and to transmit the function 160 to the POSD for implementation. The tracking element is arranged to track respective responses 162, by the at least one end user, to a plurality of implementations of GUI I/O function 160 by the GUI. The comparison element is arranged to compare respective responses 160 with performance parameter 122. The comparison element also is arranged to compare the comparison of the responses 114 with the parameter 122 with the comparison of responses 160 with parameter 122. That is, the comparison element determines how functions 116 and 160 performed with respect to parameter 122. The configuration element is arranged to generate configuration 126 in accordance with the comparison of the responses 114 with the parameter 122 with the comparison of responses 160 with parameter 122. For example, if function 116 is a red button on a touch screen and function 160 is a blue button on the touch screen, system 100 will use which ever of the buttons did best with respect to parameter 122.

System 100 can generate, track, and execute optimal I/O functions, for example, function 116, or experimental I/O functions, such as function 160, on a fixed or periodic basis so that optimized functions can be tested against experimental functions on a regular basis. In one embodiment, the tracking element is arranged to generate at least one executable 164 using one or both of set of rules 165 or artificial intelligence program 166 stored in the memory unit of the computer. In this case, the tracking element is arranged to generate function 160 using executable 164. In one embodiment, executable 164 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 186 transmits modifying rule 192 to computer 110. Computer 110 stores modifying rule 192 in memory 124. Element 102 modifies executable 164 using rule 192. Computer 186 generates rule 192, and element 102 modifies executable 164, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In a sixth embodiment, system 100 automatically generates the performance parameters used to optimize the system, for example, parameters 122 and 141 and determines when and how to use the performance parameters. In one embodiment, element 102 is arranged to generate at least one executable 168, using one or both of set of rules 170 and artificial intelligence program 172 stored in the memory unit. In this case, element 102 is arranged to automatically generate parameter 122 using executable 168. In one embodiment, executable 168 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 186 transmits modifying rule 194 to computer 110. Computer 110 stores modifying rule 194 in memory 124. Element 102 modifies executable 168 using rule 194. Computer 186 generates rule 194, and element 102 modifies executable 168, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In another embodiment, element 102 is arranged to generate at least one executable 174, using at least one of a set of rules 176 or artificial intelligence program 178 stored in the memory unit. In this case, element 102 is arranged to automatically generate parameter 141 using executable 174. In one embodiment, executable 174 is generated as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, computer 186 transmits modifying rule 196 to computer 110. Computer 110 stores modifying rule 196 in memory 124. Element 102 modifies executable 174 using rule 196. Computer 186 generates rule 196, and element 102 modifies executable 174, respectively, as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed concurrently.

In a seventh embodiment, system 100 controls I/O functions for promotions or advertisements. The functions can be adjusted in a consumer specific way or in a general way. For example, POSD 120 detects a consumer in its vicinity using any means known in the art, for example, via sensors or via a WCD in the possession of the customer. If the identity of the customer cannot be determined, system 100 determines what types of promotions, for example, the content of the promotion and the I/O function used to present the content, have been successful in the past according to one or more performance metrics. For example, system 100 can use transaction volume as the performance metric or parameter. As another example, the system measures the amount of sales of an item when it is promoted at various times of the day and uses the historical sales data along with the types of I/O functions used to determine what types of promotions and I/O functions to use.

System 100 also can determine what type of advertisement or promotion has been successful for the identified customer in the past, for example, by examining transaction history 180 for the customer, and executes appropriate I/O functions based on the historical success of the functions. The transaction history is an account of previous transactions by the customer. History 180 is shown as data stored in memory element 124 of the computer; however, it should be understood that the history can be retrieved by computer 110, via the interface element, for use by the processor, from another system or memory unit (not shown) or can be generated by processor 108.

System 100 can generate, track, execute, and modify any I/O function known in the art. The following are non-limiting examples of I/O functions applicable to system 100:

1. Welcome Page: a welcome page displays a greeting and pre order offer.

2. Loyalty Program Page: a loyalty program page displays information regarding one or more loyalty programs in which a particular consumer is participating.

3. Cashier Incentive Page: a cashier incentive page displays information regarding one or more incentive programs in which a cashier is participating.

4. Order Screen: displays items to order.

5. Menu: displays items to order.

6. Sub Menu: displays sub items to order.

7. Order and Subtotal: displays current order including subtotal including the ability to add, remove and modify items.

8. Suggestive Sell: displays offers at different times of the order including: Before order is made; During order entry; After order is placed; and After order is ready.

9. Promotion-displays advertisements for store and third party merchandise: some advertisements can be for items that are available in the store while others are not available.

10. Confirmation Screen: displays a confirmation of the order along with appropriate upsells, order, and total information.

11. Payment options: displays different types of payment options plus confirmation of payment buttons.

12. Thank You Screen: displays messages once the order is completed.

The following are non-limiting examples of I/O function configurations and re-configurations applicable to system 100:

1. Size and shape of order buttons.

2. Size and type of font.

3. Colors of buttons and fonts.

4. The relational size of buttons and fonts to one another.

5. The name of buttons.

6. Whether or not a particular button is available on a given screen.

7. Where a particular button is placed on a screen.

8. Flashing or other visual type queues of a button or font.

9. Placement of images on a screen.

10. Size of images on a screen.

11. Placement of videos on a screen.

12. Size of videos on a screen.

13. The total number of buttons on a page.

14. Whether a category of buttons is available on a particular page.

15. What buttons in a category are available on a page.

16. The greeting message that is displayed or spoken on a page.

17. The thank you message that is displayed or spoken on a page.

18. Voice files of items.

19. Voice files of suggestive selling offers.

20. Voice files of order totals.

21. Voice files of cashier names.

22. Voice files of consumer names.

23. Audio files of promotions.

In general, a GUI allows end users to place orders into a device. The interface of the GUI executes the I/O functions noted supra, for example, a screen on the GUI can display items for purchase, subtotals, suggestive selling routines, surveys, promotions, and loyalty program information. System 100 is configured for any I/O functionality known in the art, such a keyboard, a screen, a touch screen, audio, and voice commands. System 100 also is configured to receive consumer and cashier identifiers such as credit cards, loyalty cards, biometric identifiers, cell phone numbers, and any other method of identification known in the art. As noted supra, system 100 tracks usages of the layout of the GUI, for example, through the I/O functions, and reconfigures the layout for optimal usage. Optimal usage can be for general orders, cashier specific orders and/or customer specific orders.

The following is an exemplary discussion of system 100 for use by a cashier at a retail location, for example, location 136. The cashier identifies themselves at the beginning of a session on the POSD. GUI 118 includes a touch screen and I/O function 116 includes a standard, or default, display of buttons, screens, and pull down menus on the touch screen. Element 102 tracks responses 114, in this case the usage of the buttons, screens, and pull-down menus by the cashier. The comparison element compares the usage to performance parameter 122, in this case, the parameter is a threshold value of 10% usage. For example, the comparison element notes which of the buttons, screens, or pull-down menus is used less than 10% of the time they are displayed. The configuration element generates configuration 126. In this case the configuration is to remove and move to a sub-level, the buttons, screens, or pull-down menus used less than 10% of the time, and to re-configure the remaining buttons, screens, and pull-down menus accordingly. The configuration element then transmits the configuration to the POSD so that the remaining buttons, screens, and pull-down menus are displayed according to configuration 126. The preceding procedure can be used when the end user is a customer. As a corollary to the above example, the tracking element can correlate the usage of the buttons, screens, or pull-down menus with sales activity, such a size of order, and configure the layout of the touch screen to emphasize the buttons, screens, or pull-down menus that are associated with increases in order size.

Alternately stated, system 100 changes the number, type, and function of GUI I/O functions based on actual cashier use and/or preferences. In some embodiments, modifications are made manually by the cashier and implemented by system 100. Thus, system 100 determines which I/O functions are unused and re-configures GUI I/O functions accordingly. For example, unused buttons on a touch screen can be moved to sub-screen and a button added to point to the unused buttons. As another example, if system 100 determines only two functions on a sub-menu are used above a threshold frequency, the system can delete the sub-menu from a screen and replace the sub-menu with respective buttons for the two functions used above a threshold frequency. In this manner, a step is saved and the frequently used sub-menu button(s) are raised up one or more levels to improve operator efficiency.

In one embodiment, elements 102 and 104 determine which I/O functions for the GUI, among all I/O functions for GUI 118, are applicable with respect to performance parameters, such as parameter 122, for example, which functions are most frequently used, and also determine the most common sequence of use for these I/O functions. The configuration element generates configuration 126 which includes results in the following I/O functions 128: a “popular choices menu,” providing a choice of one or more re-configured functions 128: a new main screen based upon the determination; modifies all the menus/screens in a new, more efficient order; and/or any or all of the above. The original I/O functions 128 can be saved to memory 124 (or another memory unit not shown) by the processor and a toggle function button (not shown) generated and transmitted for display on the GUI. The toggle button selects, and causes to be implemented on the GUI, the original function 128 or the re-configured function 128 described supra.

The system can carry out the above processes for individual cashiers and/or based upon aggregate usage and/or a combination of these, so that, the system recognizes the cashier using the system and presents the ideal or modified screens based upon user identification and/or experience levels. For example, the identification of a user can include information regarding the experience level of the user and the I/O functions 128 implemented are selected according to experience level. For example, a new or untrained cashier can be given the original functions 128, while experience cashiers can be give the re-configured functions 128.

The following is an exemplary discussion of system 100 for use by a customer at a retail location, for example, location 136. The customer identifies themselves to place an order at the POSD. GUI 118 includes a touch screen and I/O function 116 include a standard menu of items. Element 102 tracks responses 114 to the menu, for example, buttons selected as part of the ordering process. Profitability is selected as performance parameter 122. The comparison element compares the buttons selected as part of the respective orders with the profitability of the respective orders and identifies the buttons associated with the highest profitability. The configuration element generates configuration 126 for function 128 to highlight the buttons associated with the highest profitability or to remove or minimize buttons associated with lower profitability. The configuration element transmits the configuration to the POSD so that the re-configured buttons and menu are displayed when the customer is identified at POSD 120. A button enabling the customer to toggle to the standard menu can be included in the screen for the re-configured function 128.

System 100 is adaptable to any retail setting or location known in the art. For example, the system can be configured so that the transaction flow of the GUI is different depending on where POSD 120 is placed, and what type of retail environment is using the system. For example, a restaurant can use system 100 to place orders while a grocery store can use system 100 as part of a check out station. In one embodiment, any sensor known in the art can be used to detect the presence of a consumer and offer a chance to begin the order or checkout process when the consumer is in a certain geographic area.

In one embodiment, the entire GUI can be adjusted as one piece of code. In another embodiment, the GUI can adjust itself on a screen by screen basis depending on how the cashier or consumer used the previous screen. System 100 can be used in a single retail location or a limited number of locations to determine optimal I/O functions and thus, optimal GUI presentations. Once system 100 is optimized, the results can be used among a larger number of locations.

I/O functions for promotions or advertisements can also be controlled using system 100. The functions can be adjusted in a consumer specific way or in a general way. For example, POSD 120 detects a consumer in its vicinity, for example, via the sensors noted above or via a wireless communications device in the possession of the customer. The location of the WCD can be determined using any means known in the art, including, but not limited to, GPS technology and information from a network to which the WCD is connected (further described below). If the identity of the customer cannot be determined, system 100 determines what types of promotions have been successful in the past, in general, according to one or more performance metrics. For example, system 100 may use the time of day or transaction volume as the performance metric or parameter. For example, the system measures the amount of sales of an item when it is promoted at various times of the day and uses the historical sales data to determine what types of promotions to show and how to present the promotions. For example, the system could determine that an audio presentation was most successful during busy periods and a visual presentation was most successful during less busy periods.

If the identity of the customer is known, for example, a customer has contacted the retail location using a WCD, or the customer supplies identification information to the POSD, system 100 can determine what type of advertisement or promotion has been successful for the identified customer in the past, for example, by examining transaction history 182 for the customer, and executes appropriate I/O functions based on their historical success of the functions. History 182 is shown as data stored in memory element 124 of the computer; however, it should be understood that the history can be retrieved by computer 110, via the interface element, for use by the processor, from another system or memory unit (not shown) or can be generated by processor 108.

It should be understood that the sets of rules described supra can be a single set of rules (not shown) or can be combined in other groupings (not shown). For example, rules 148 and 170 can be combined in a single set of rules. In like manner, the artificial intelligence programs described supra can be a single program (not shown) or can be combined in other groupings (not shown). For example, programs 156 and 166 can be combined in a single program.

It should be understood that various storage and removal operations, not explicitly described above, involving memory 124 and as known in the art, are possible with respect to the operation of system 100. For example, outputs from and inputs to the general-purpose computer can be stored and retrieved from the memory elements and data generated by the processor can be stored in and retrieved from the memory.

It should be understood that system 100 can be operated by the same business entity operating or owning a retail location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 136 or with a business entity operating the business location. It also should be understood that system 100 can be wholly or partly separate from the computer operating system for a retail location, for example, location 136 or with a business entity operating the business location. It should be further understood that system 100 can interface with a plurality of POSDs and with a plurality of POSDs at a plurality of different locations, for example, at cashier stations at different business locations and WCDs located remotely from business locations.

It should be understood that the examples above regarding executables, for example executables 146 and 152, are non-limiting, are meant to provide only a broad overview, and do not address the number, complexity, structure, or interrelationships of the operations included in the actual generation of the executables.

As noted supra, POSD 120 can be a WCD, for example, POSD 120A. A WCD is defined supra. The WCD can be any WCD known in the art. In one embodiment, the WCD is owned by, leased by, or otherwise already in possession of the end user when system 100 interfaces with the WCD. In general, the WCD communicates with a network, for example, network 184, via radio-frequency connection 186. Network 184 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 184 using any means known in the art, including, but not limited to a hardwire connection, an optical connection, an Internet connection, or a radio frequency connection. In the figures, a non-limiting example of a hardwire connection 188 is shown. In one embodiment, WCD 120A is connectable to a docking station (not shown) to further enable communication between the WCD and system 100. Any docking station or docking means known in the art can be used. That is, when the device is connected to the docking station, a link is established between the device and system 100.

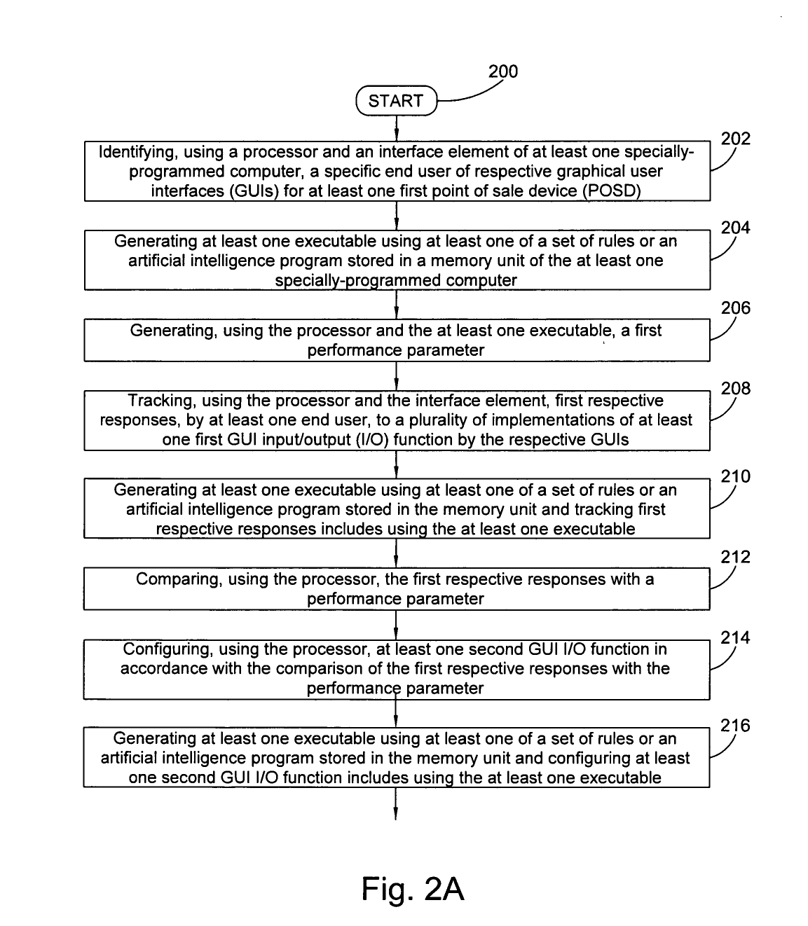

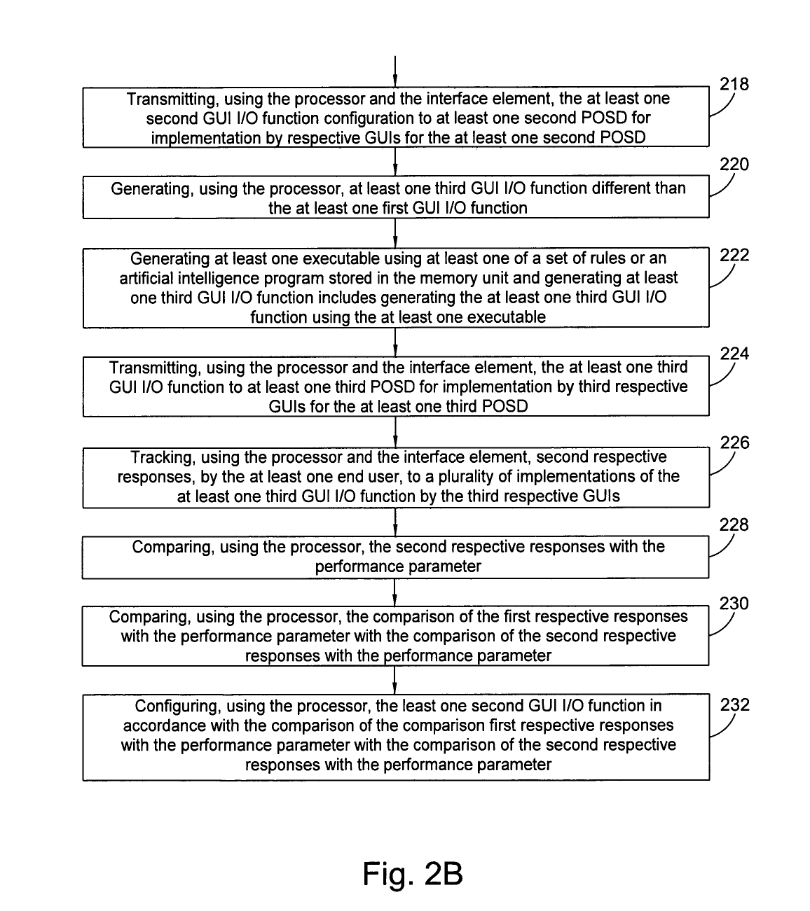

FIG. 2 is a flow chart illustrating a present invention computer-based method for controlling a graphical user interface (GUI) for a point of sale device (POSD). Although the method in FIG. 2 is depicted as a sequence of numbered steps for clarity, no order should be inferred from the numbering unless explicitly stated. The method starts at Step 200. Step 208 tracks, using a processor and an interface element in at least one specially-programmed computer, first respective responses, by at least one end user, to a plurality of implementations of at least one first GUI input/output (I/O) function by respective GUIs for at least one first POSD. Step 212 compares, using the processor, the first respective responses with a first performance parameter. Step 214 configures, using the processor, at least one second GUI I/O function in accordance with the comparison of the first respective responses with the first performance parameter. Step 218 transmits, using the processor and the interface element, the at least one second GUI I/O function configuration to at least one second POSD for implementation by respective GUIs for the at least one second POSD.

In one embodiment, step 202 identifies, using the processor and the interface element, a specific end user of the GUI. Tracking first respective responses includes tracking first respective responses for the specific end user, comparing the first respective responses includes comparing the first respective responses for the specific end user, configuring at least one second GUI I/O function includes configuring a specific GUI I/O function for the specific user in accordance with the comparison of the first respective responses for the specific end user, and transmitting the at least one second GUI I/O function configuration includes transmitting the specific GUI I/O function configuration to the second POSD when the specific user is identified at the POSD. In a first embodiment, the first performance parameter is associated with first sales activity at a retail location. In one embodiment, the first sales activity is selected from the group consisting of speed for placement of an order using the first respective GUIs, maximum profit for the order, maximum total for the order, lowest return rate, and sales activity for a plurality of orders placed using the first respective GUIs. In another embodiment, the first performance parameter is associated with an additional sales activity at the retail location or with a temporal parameter.

In a second embodiment, the first performance parameter is a frequency of usage of the at least one first GUI I/O function by the at least one end user and configuring at least one second GUI I/O function includes enabling the second I/O function according to the frequency of usage of the at least one first GUI I/O function. In one embodiment, enabling the second GUI I/O function according to the frequency of usage of the at least one first GUI I/O function includes disabling the at least one second GUI I/O function if the frequency of usage of the at least one first GUI I/O function is below a predetermined threshold.

In a third embodiment, step 210 generates at least one executable using at least one of a set of rules or an artificial intelligence program stored in a memory unit of the computer and tracking first respective responses includes using the at least one executable. In a fourth embodiment, step 216 generates at least one executable using at least one of a set of rules or an artificial intelligence program stored in a memory unit of the computer and configuring at least one second GUI I/O function includes using the at least one executable. In a fifth embodiment, configuring at least one second GUI I/O function includes configuring in real time or at a predetermined interval.

In a sixth embodiment, the at least one end user is at least one customer and the first performance parameter is acceptance of a first offer by the at least one customer or a sales activity at the retail location associated with a second offer made to the at least one customer. In a seventh embodiment, step 222 generates, using the processor, at least one third GUI I/O function different than the at least one first GUI I/O function. Step 224 transmits, using the processor and the interface element, the at least one third GUI I/O function to at least one third POSD for implementation by third respective GUIs for the at least one third POSD. Step 226 tracks, using the processor and the interface element, second respective responses, by the at least one end user, to a plurality of implementations of the at least one third GUI I/O function by the third respective GUIs. Step 228 compares, using the processor, the second respective responses with the first performance parameter. Step 230 compares, using the processor, the comparison of the first respective responses with the first performance parameter with the comparison of the second respective responses with the first performance parameter. Step 232 configures, using the processor, the least one second GUI I/O function in accordance with the comparison of the comparison of the first respective responses with the first performance parameter with the comparison of the second respective responses with the first performance parameter. In one embodiment, step 220 generates at least one executable using at least one of a set of rules or an artificial intelligence program stored in a memory unit of the computer and configuring at least one third GUI I/O function includes configuring the at least one third GUI I/O function using the at least one executable.

In an eighth embodiment, the first and second I/O functions are the same. In a ninth embodiment, step 204 generates at least one executable using at least one of a set of rules or an artificial intelligence program stored in a memory unit of the computer and step 206 generates, using the processor and the at least one executable, the first performance parameter.

The following is a listing of exemplary hardware and software that can be used in a present invention method or system. It should be understood that a present invention method or system is not limited to any or all of the hardware or software shown and that other hardware and software are included in the spirit and scope of the claimed invention.

Order entry device 1-n

Central System

GUI Adaptation Program

GUI Display Program

Promotion Adaptation Program

Promotion Display Program

The following is a listing of exemplary data bases that can be used in a present invention method or system. It should be understood that a present invention method or system is not limited to any or all of the databases shown and that other databases are included in the spirit and scope of the claimed invention.

Central System

Order Entry Device Type 1-n

Device Type ID

Device Type Descriptor

Allowable GUI 1-n

Order Entry Device 1-n

Device ID

Device Type

Allowable GUI 1-n

GUI Database

GUI ID

GUI attributes 1-n

GUI conditions 1-n

GUI buttons 1-n

GUI fonts 1-n

GUI screens 1-n

GUI colors 1-n

GUI Promotions 1-n

GUI Cashier 1-n

GUI Cashier Class 1-n

GUI Customer 1-n

GUI Customer Class 1-n

Cashier Database

Cashier ID

Cashier Profile

Transaction History

Cashier GUI Profile

Cashier Class

Customer Database

Customer ID

Transaction History

GUI Profile

Customer Class

Inventory Database

ID

Type

Subtype

GUI conditions

Price

Inventory Class

Suggestive Sell Offer Database

ID

Type

Subtype

GUI conditions

Suggestive Sell Class

Transaction Database

Date

Inventory ID 1-n

Type

Subtype

GUI 1-n

Order Total

Promotion Database

ID

Type

Subtype

GUI conditions

Greeting Database

ID

Type

Subtype

GUI conditions

GUI components 1-n

Promotion Class

Thank You Screen Database

ID

Type

Subtype

GUI conditions

GUI components 1-n

Class ID

Promotion Device Type Database

Device Type

GUI conditions 1-n

Class ID

Promotion Device Database

ID

Type

GUI conditions 1-n

GUI Adaptation Conditions Database

ID

Condition descriptor

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A computer-based method for controlling a graphical user interface (GUI) for a point of sale device (POSD), comprising the steps of:
tracking, using a processor and an interface element in at least one specially-programmed computer, first respective responses, by at least one end user, to a plurality of implementations of at least one first GUI input/output (I/O) function by respective GUIs for at least one first POSD;
comparing, using the processor, the first respective responses with a first performance parameter;
configuring, using the processor, at least one second GUI I/O function in accordance with the comparison of the first respective responses with the first performance parameter; and,
transmitting, using the processor and the interface element, the at least one second GUI I/O function configuration to at least one second POSD for implementation by respective GUIs for the at least one second POSD.

2. The method of claim 1 further comprising identifying, using the processor and the interface element, a specific end user of the GUI; and, wherein tracking first respective responses includes tracking first respective responses for the specific end user, wherein comparing the first respective responses includes comparing the first respective responses for the specific end user, wherein generating a configuration for at least one second GUI I/O function includes configuring a specific GUI I/O function for the specific user in accordance with the comparison of the first respective responses for the specific end user, and wherein transmitting the at least one second GUI I/O function configuration includes transmitting the specific GUI I/O function configuration to the second POSD when the specific user is identified at the POSD.

3. The method of claim 1 wherein the first performance parameter is associated with first sales activity at a retail location or includes a temporal parameter.

4. The method of claim 1 wherein the first performance parameter is a frequency of usage of the at least one first GUI I/O function by the at least one end user and wherein configuring at least one second GUI I/O function includes enabling the second I/O function according to the frequency of usage of the at least one first GUI I/O function.

5. The method of claim 1 further comprising generating at least one executable using at least one of a set of rules or an artificial intelligence program stored in a memory unit of the computer and wherein tracking first respective responses includes using the at least one executable.

6. The method of claim 1 further comprising generating at least one executable using at least one of a set of rules or an artificial intelligence program stored in a memory unit of the computer and wherein configuring at least one second GUI I/O function includes using the at least one executable.

7. The method of claim 1 wherein the at least one end user is at least one customer and wherein the first performance parameter is acceptance of a first offer by the at least one customer or a sales activity at the retail location associated with a second offer made to the at least one customer.

8. The method of claim 1 further comprising:
generating, using the processor, at least one third GUI I/O function different than the at least one first GUI I/O function;
transmitting, using the processor and the interface element, the at least one third GUI I/O function to at least one third POSD for implementation by third respective GUIs for the at least one third POSD;
tracking, using the processor and the interface element, second respective responses, by the at least one end user, to a plurality of implementations of the at least one third GUI I/O function by the third respective GUIs;
comparing, using the processor, the second respective responses with the first performance parameter;
comparing, using the processor, the comparison of the first respective responses with the first performance parameter with the comparison of the second respective responses with the first performance parameter; and,
configuring, using the processor, the least one second GUI I/O function in accordance with the comparison of the comparison of the first respective responses with the first performance parameter with the comparison of the second respective responses with the first performance parameter.

9. The method of claim 8 further comprising generating at least one executable using at least one of a set of rules or an artificial intelligence program stored in a memory unit of the computer and wherein generating at least one third GUI I/O function includes generating the at least one third GUI I/O function using the at least one executable.

10. The method of claim 1 wherein the first and second I/O functions are the same.

11. The method of claim 1 further comprising:
generating at least one executable using at least one of a set of rules or an artificial intelligence program stored in a memory unit of the computer; and,
generating, using the processor and the at least one executable, the first performance parameter.

12. A system for controlling a graphical user interface (GUI) for a point of sale device (POSD), comprising:
a tracking element, in a processor for at least one specially-programmed computer, arranged to track, using an interface element in the computer, first respective responses, by at least one end user, to a plurality of implementations of at least one first GUI input/output (I/O) function by respective GUIs for at least one first POSD;
a comparison element, in the processor, arranged to compare the first respective responses with a first performance parameter stored in a memory unit for the computer; and,
a configuration element, in the processor, arranged to configure at least one second GUI I/O function in accordance with the comparison of the first respective responses with the first performance parameter and arranged to transmit, using the interface element, the at least one second GUI I/O function configuration to at least one second POSD for implementation by respective GUIs for the at least one second POSD.

13. The system of claim 12 further comprising an identification element, in the processor, arranged to identify, using the interface element, a specific end user of the GUI; and, wherein the tracking element is arranged to track first respective responses for the specific end user, wherein the comparison element is arranged to compare the first respective responses for the specific end user, wherein the configuration element is arranged to generate a specific GUI I/O function for the specific user in accordance with the comparison of the first respective responses for the specific end user, and wherein the configuration element is arranged to transmit the specific GUI I/O function to the second POSD when the specific user is identified at the POSD.

14. The system of claim 12 wherein the first performance parameter is associated with first sales activity at a retail location or includes a temporal parameter.

15. The system of claim 12 wherein the first performance parameter is a frequency of usage of the at least one first GUI I/O function by the at least one user and wherein the configuration element is arranged to enable the second I/O function according to the frequency of usage of the at least one first GUI I/O function.

16. The system of claim 12 wherein the tracking element is arranged to generate at least one executable using at least one of a set of rules or an artificial intelligence program stored in a memory unit of the computer and to track the first respective responses using the at least one executable.

17. The system of claim 12 wherein the configuration element is arranged to generating at least one executable using at least one of a set of rules or an artificial intelligence program stored in a memory unit of the computer and to configure the at least one second GUI I/O function using the at least one executable.

18. The system of claim 12 wherein the at least one end user is at least one customer and wherein the first performance parameter is acceptance of a first offer by the at least one customer or a sales activity at the retail location associated with a second offer made to the at least one customer.

19. The system of claim 12 wherein:
the configuration element is arranged to generate at least one third GUI I/O function different than the at least one first GUI I/O function and to transmit the at least one third GUI I/O function to at least one third POSD for implementation by third respective GUIs for the at least one third POSD;
the tracking element is arranged to track second respective responses, by the at least one end user, to a plurality of implementations of the at least one third GUI I/O function by the third respective GUIs;
the comparison element is arranged to compare the second respective responses with the first performance parameter;
the comparison element is arranged to compare the comparison of the first respective responses with the first performance parameter with the comparison of the second respective responses with the first performance parameter; and,
the configuration element is arranged to configure the least one second GUI I/O function in accordance with the comparison of the comparison of the first respective responses with the first performance parameter with the comparison of the second respective responses with the first performance parameter.

20. The system of claim 19 wherein the tracking element is arranged to generate at least one executable using at least one of a set of rules or an artificial intelligence program stored in a memory unit of the computer and to generate the at least one third GUI I/O function using the at least one executable.

21. The system of claim 12 wherein the first and second I/O functions are the same.

22. The system of claim 12 wherein the tracking element is arranged to generate at least one executable using at least one of a set of rules or an artificial intelligence program stored in a memory unit of the computer and to generate, using the processor and the at least one executable, the first performance parameter.

23. A computer-based method for controlling a graphical user interface (GUI) for a point of sale device (POSD), comprising the steps of:
tracking, using a processor and an interface element in at least one specially-programmed computer, respective responses, by an end user, to a plurality of implementations of a GUI input/output (I/O) function by respective GUIs for at least one POSD;
comparing, using the processor, the respective responses with a performance parameter;
generating, using the processor, at least one executable using at least one of a set of rules and an artificial intelligence program stored in a memory unit of the computer;
configuring, using the processor and the at least one executable, the GUI I/O function in accordance with the comparison of the respective responses with the performance parameter; and,
transmitting, using the processor and the interface element, the GUI I/O function configuration to the at least one POSD for implementation by the respective GUIs, when the end user is identified at the at least one POSD.
